(19) United States
(12) Patent Application Publication
(10) Pub. No.: US 2017/0089401 A1
(43) Pub. Date: Mar. 30, 2017

(54) Telescopic half shaft and portions thereof

(71) Applicant: Dimitris Korres, Athens (GR)

(72) Inventor: Dimitris Korres, Athens (GR)

(21) Appl. No.: 15/282,773

(22) Filed: Sep. 30, 2016

Related U.S. Application Data
(60) Provisional application No. 62/235,549, filed on Sep. 30, 2015.

(51) Int. Cl. F16D 3/06; F16D 1/068; F16D 1/06; F16C 3/03

(52) U.S. Cl. CPC F16D 3/065; F16C 3/03; F16D 1/068; F16D 1/06

(57) ABSTRACT

A telescopic half shaft designed to efficiently transfer torque comprising an outer part, an inner part, and a connector. Torque is transferred between the outer part and the inner part through radially placed rollers at the edge of the inner part. The radially placed rollers roll in specifically formed grooves on the inside of the outer part. The inner part and the outer part are aligned through a low friction bushing fitted at the open end of the outer part. The design allows for a longer slender shaft section of the inner part which increases torsional ductility.

### FIELD OF ART

The disclosed device generally relates to the automotive field, and more specifically to an improved telescopic half shaft. Telescopic half shafts are commonly used in the automotive field to enable torque transfer from the differential of a vehicle to the wheels of a vehicle.

### BACKGROUND

Modern front wheel drive cars typically combine the transmission (i.e. gearbox and differential) and front axle into a single unit called a transaxle. The drive axle is a split axle with a differential and universal joints between the two half axles. Each half axle connects to the wheel by use of a constant velocity joint which allows the wheel assembly to move freely vertically as well as to pivot when making turns

In rear wheel drive vehicles, the engine turns a driveshaft which transmits rotational force to a drive axle at the rear of the vehicle. The drive axle may be a live axle, but modern rear wheel drive vehicles generally use a split axle with a differential. In such cases, one half axle or half shaft connects the differential with the left rear wheel, a second half shaft does the same with the right rear wheel; thus the two half shafts and the differential constitute the rear axle.

FIG. 1 (prior art) illustrates a typical transmission arrangement of a vehicle showing a differential (100), wheels (110), and a minimum length (α) of a half shaft (not shown). FIG. 2 (prior art) illustrates a typical transmission arrangement of a vehicle when one of the wheels (110) is in a displaced position. Due to the geometrical properties of this layout the distance between the wheel center and the differential varies with suspension movement. In FIG. 2 length (β) of a half shaft (not shown) when a wheel is in a displaced position is longer than the length of a half shaft when the wheel is not displaced. For performance reasons a half shaft capable of expanding and retracting as the distance between the differential and wheels vary during vehicle operation is desired.

Long travel telescopic half shafts are used to solve this problem in vehicles that carry driving wheels on long trailing or leading arms of an independent suspension system. In a typical vehicle arrangement the wheels are coupled to a differential through an arrangement of plunging constant velocity joints and a telescopic half shaft. The term “long travel” is characterized as the plunge length (or float) of a half shaft that cannot be compensated by the plunging continuous velocity joints of the conventional technology.

A telescopic half shaft allows for the transfer of torque from the differential to the wheels as the distance between the wheels and the differential varies. Telescopic half shafts are typically comprised of two basic parts; an inner part and an outer part. Conventional technology accomplishes torque transfer from one part of the shaft to the other using a simple trapezoidal cross-sectioned spline or with a spline of semi circled grooves that house small metal balls.

FIGS. 3, 5 (prior art) show the cross-sections of typical outer and inner shaft parts of a conventional telescopic half shaft with a trapezoidal spline. The trapezoidal grooves in the inner face of the hollow shaft of FIG. 3 can be seen in FIG. 4 (prior art).

FIGS. 6, 8 (prior art) show the cross-sections of typical outer and inner shaft parts of a telescopic half shaft with a spline of semi circled grooves that house small metal ball bearings. The semi-circle grooves in the inner face of the hollow shaft of FIG. 6 can be seen in FIG. 7 (prior art).

Consequently, the inner part of the telescopic half shaft consists of a long section with a large diameter to accommodate either the trapezoidal spline or semi circled grooves. Because of this the slender shaft section of the inner part is typically very short as compared to a simple half shaft.

FIG. 10 (prior art) shows an elevational view of a typical inner shaft portion of a telescopic half shaft, the slender high torsional ductility shaft section having a length (L1). FIG. 11 (prior art) shows an elevational view of a typical simple half shaft, the slender high torsional ductility shaft section having a length (L2). It can be recognized that the length of the slender high torsional ductility shaft section is significantly reduced in conventional telescopic half shafts.

It can also be recognized that the slender shaft section of a telescopic half shaft is the mechanism that allows for flex under torsional stresses. FIG. 12 (prior art) shows a typical simple half shaft and the torsional shaft flex relative to shaft length, with the angle of total torsional flex (Φ) and the angle of ultimate torsional flex of shaft material (Y). FIG. 13 (prior art) shows a typical inner shaft part of a telescopic half shaft and the torsional shaft flex relative to shaft length, with the angle of total torsional flex (φ) and the angle of ultimate torsional flex of shaft material (Y). With a significantly shorter slender shaft section the overall angle of torsional ductility of a typical telescoping half shaft is reduced as compared to a typical simple half shaft.

The designs of conventional telescoping half shafts induce great friction, negatively affect torque transfer, and negatively affect suspension performance. Thus, there is a need in the automotive field for an improved half shaft, with a longer slender shaft section, to better transfer torque from the differential of a vehicle to the wheels of a vehicle and help protect a vehicle's transmission during use in extreme conditions.

### SUMMARY OF DISCLOSURE

In the telescopic half shaft design disclosed herein, the torque between the inner part of the half shaft and the outer part of the half shaft is transmitted through radially placed rollers at the edge of the inner part of the half shaft. The rollers roll in specifically formed grooves on the inside of the outer part of the half shaft. The number of rollers on the inner part and the number of grooves in the outer part is from 2 to 8. The two parts (inner and outer) are aligned through a low friction connector fitted at the open end of the outer part of the half shaft. The outer part of the half shaft can be configured to connect to a constant velocity joint or a universal joint.

The inner part of the disclosed device comprises a slender shaft section that is substantially longer than a head section of the inner part. The disclosed device achieves low friction, high torsional ductility, and increased torque transfer between the differential of a vehicle and the wheels of a vehicle.

### BRIEF DESCRIPTION OF THE FIGURES

FIG. 1 (prior art) depicts a typical transmission arrangement on a trailing arm suspension system showing a differential (100), wheels (110), and the minimum length (α) of the half shaft in the arrangement.

FIG. 2 (prior art) depicts a typical transmission arrangement on a trailing arm suspension system with one of the wheels (110) in a displaced position, showing the extended length (β) of the half shaft when a wheel is in a displaced position.

FIG. 3 (prior art) is a cross-section of a typical outer shaft part of a telescopic half shaft with an internal trapezoidal spline.

FIG. 4 (prior art) is a section view taken along line A-A of FIG. 3 showing trapezoidal grooves in the inner face of the hollow shaft.

FIG. 5 (prior art) is a cross-section of a typical inner part of a telescopic half shaft with a trapezoidal spline.

FIG. 6 (prior art) is a cross-section of a typical outer hollow shaft part of a telescopic half shaft with semi-circled grooves.

FIG. 7 (prior art) is a section view taken along line A-A of FIG. 6 showing semi-circled grooves in an inner face of the hollow shaft.

FIG. 8 (prior art) is a cross-section of a typical inner shaft part of a telescopic half shaft with ball bearings.

FIG. 9 (prior art) is a section view taken along line B-B of FIG. 8.

FIG. 10 (prior art) is an elevational view of a typical inner shaft portion of a telescopic half shaft, the slender high torsional ductility shaft section having a length (L1).

FIG. 11 (prior art) is an elevational view of a typical non-telescoping long half shaft, the slender high torsional ductility shaft section having a length (L2).

FIG. 12 (prior art) shows a typical non-telescoping half shaft and the torsional shaft flex relative to shaft length, with the angle of total torsional flex (Φ) and the angle of ultimate torsional flex of shaft material (Y).

FIG. 13 (prior art) shows a typical inner shaft part of a telescopic half shaft and the torsional shaft flex relative to shaft length, with the angle of total torsional flex (φ) and the angle of ultimate torsional flex of shaft material (Y).

FIG. 14 is a perspective view of the outer part (300) of the disclosed device showing rectangular cross-section grooves (310), inner threads (320), and splined section (330) for mounting with a constant velocity joint.

FIG. 15 is a perspective view of outer part (300) of the disclosed device with connection (340) for mounting with a universal joint.

FIG. 16 is a cross-section view of a needle roller bearing (350) showing needle rollers (360).

FIG. 17 is a perspective view of outer part (300) of the disclosed device.

FIG. 18 shows a configuration of needle roller bearings (350) alignable to fit in rectangular cross-section grooves (310) of outer part (300) of the disclosed device.

FIG. 19 is a perspective view of one configuration of inner part (400) of the disclosed device comprising a slender main shaft (410), a constant velocity joint connection (420), a shaft head (430) and roller pins (440).

FIG. 20 is a perspective view of another configuration of inner part (400) of the disclosed device in which a shaft head (430) is removably connected to slender main shaft (410) via a spline (450).

FIG. 21 is a perspective view of another configuration of inner part (400) of the disclosed device in which a shaft head (430) is affixed, i.e. welded, to slender main shaft (410) at weld area (460).

FIG. 22 is perspective view of a conical shaft aligning connector (500) for connecting inner part (400) and outer part (300) of the disclosed device and showing a flange (510) with bolt holes (520).

FIG. 23 is a cross-section view of connector (500) shown in FIG. 22 showing a bushing (530) and an oil and dust seal (540).

FIG. 24 is a cross-section view of one embodiment of the disclosed device as assembled, showing outer part (300), inner part (400), and connector (500).

FIG. 25 is a section view taken along line B-B of FIG. 24 showing needle roller bearings (350) and a shaft head (430) of inner part (400).

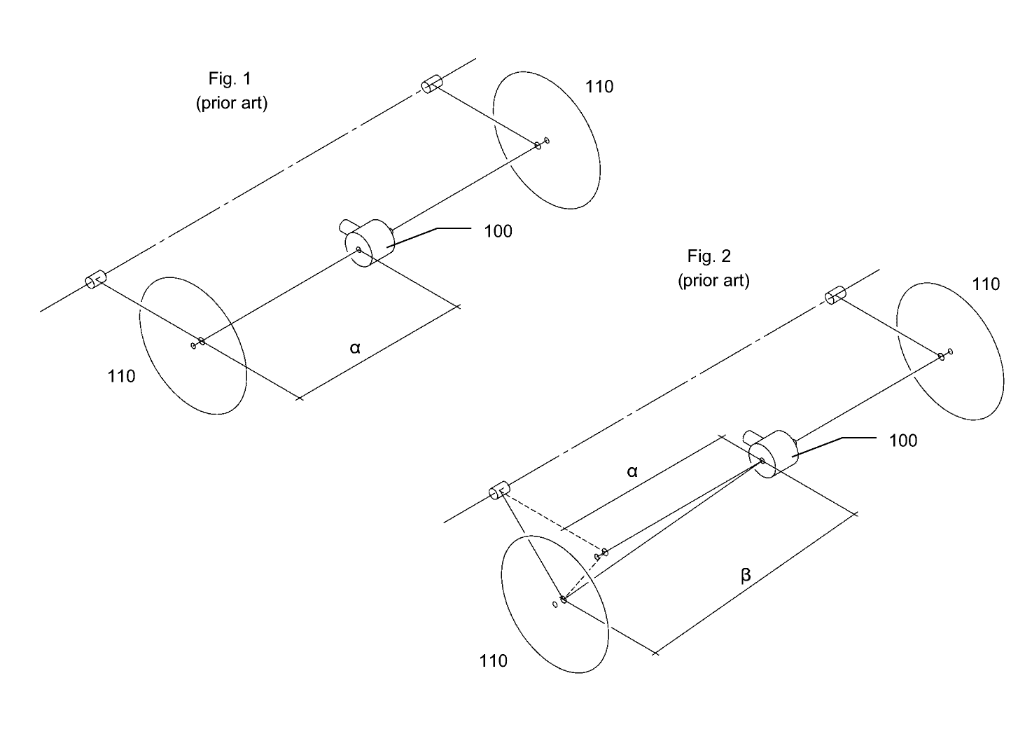

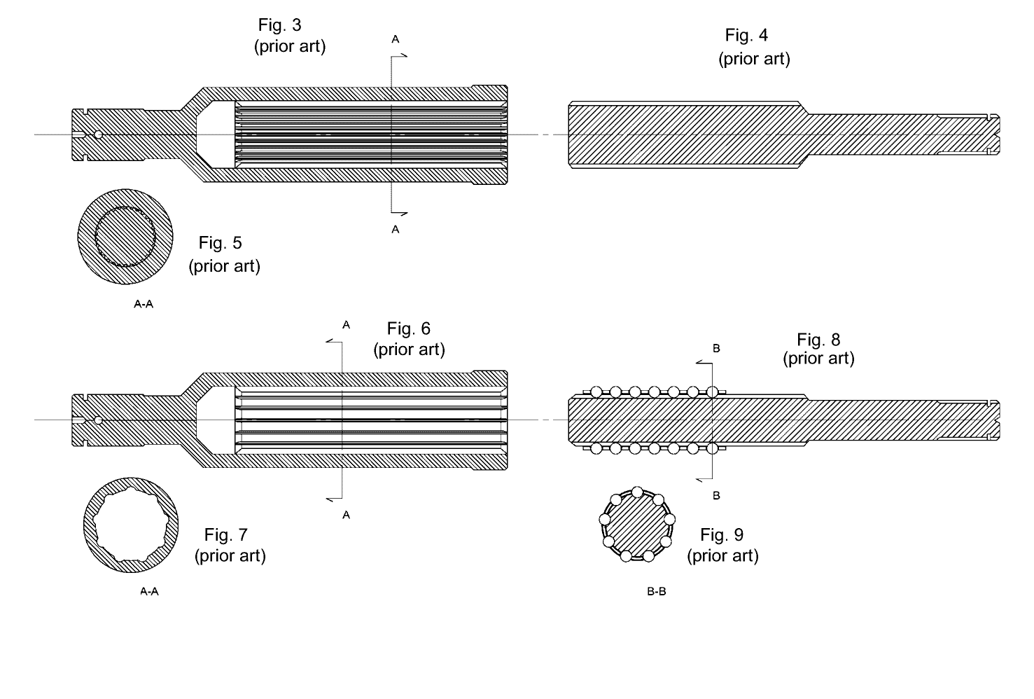

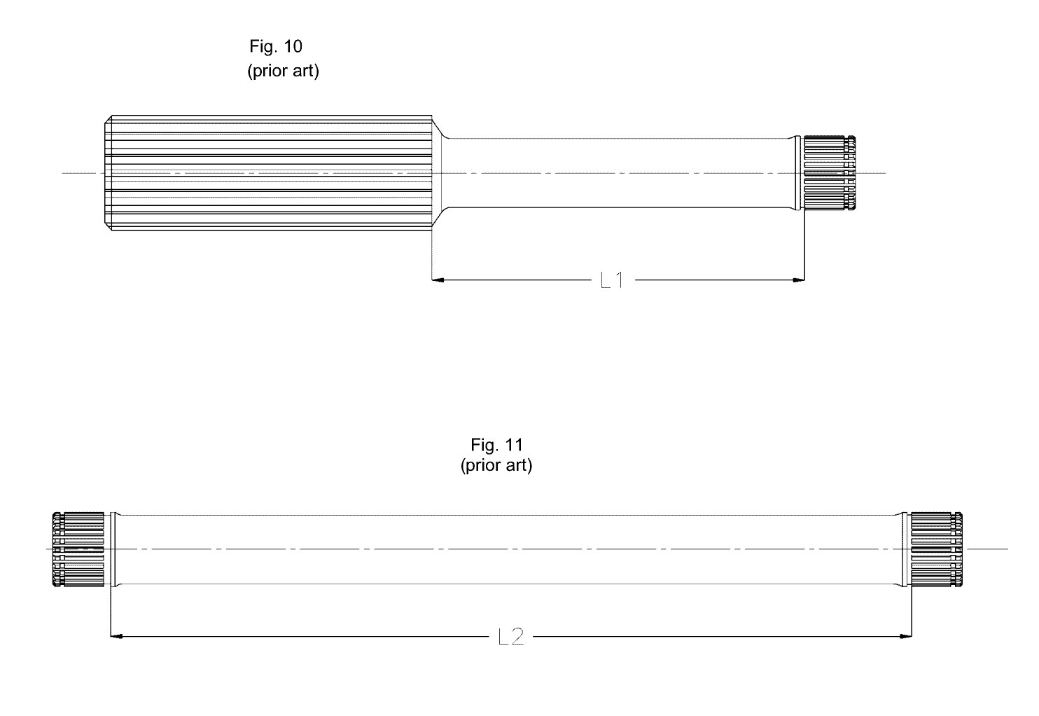

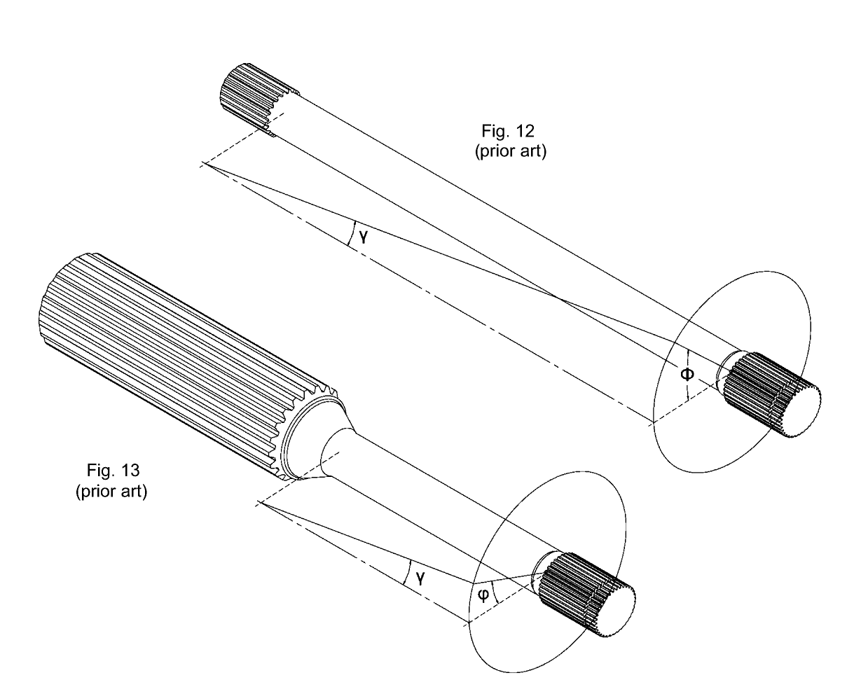

### DETAILED DESCRIPTION OF THE DISCLOSURE

The following description is provided to enable any person skilled in the art to make and use the disclosed device. Various modifications, however, will remain readily apparent to those skilled in the art, since the generic principles of the present apparatus have been defined herein specifically to provide for an improved telescopic half shaft.

The disclosed device comprises an inner part (400) and an outer part (300) through which torque is transferred. The two parts are connectable by a connector (500).

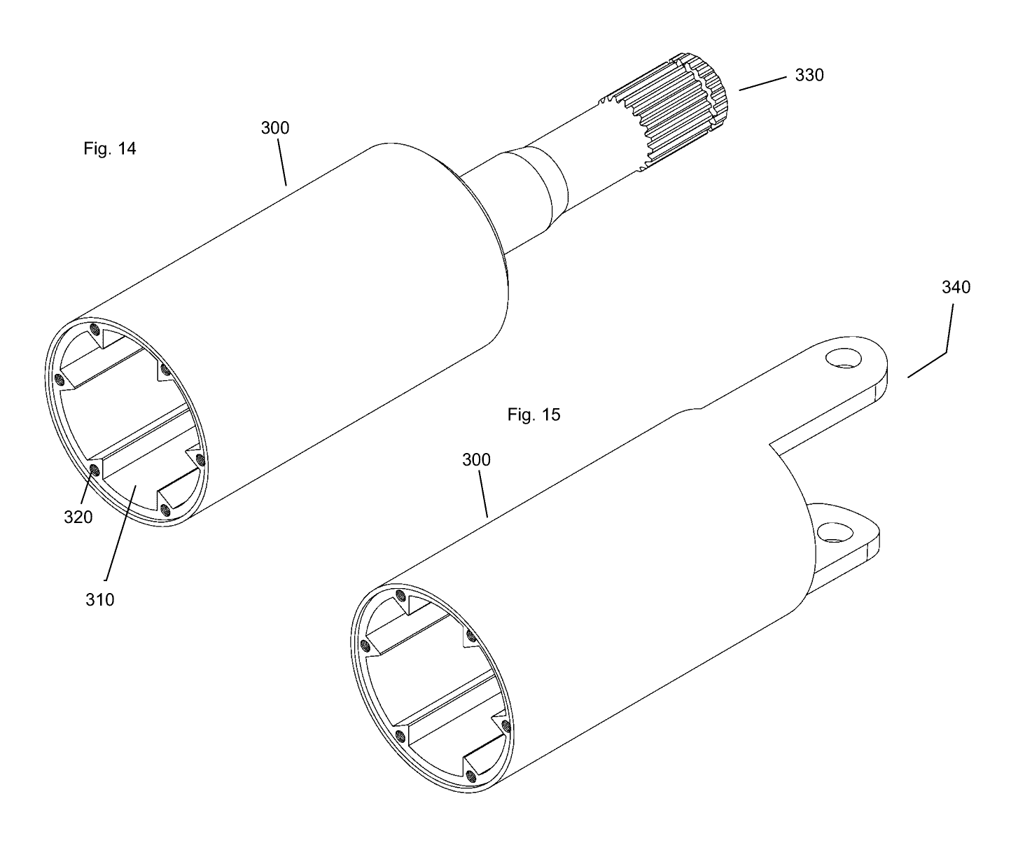

Outer part (300) of the disclosed device comprises a plurality of grooves (310), the grooves having a rectangular cross-section as shown in FIG. 14 and FIG. 15. Outer part (300) of the disclosed device can be configured with a splined section (330) for connecting with a constant velocity joint as shown in FIG. 14. Outer part (300) of the disclosed device may also be configured with a connection (340) for connecting with a universal joint as shown in FIG. 15.

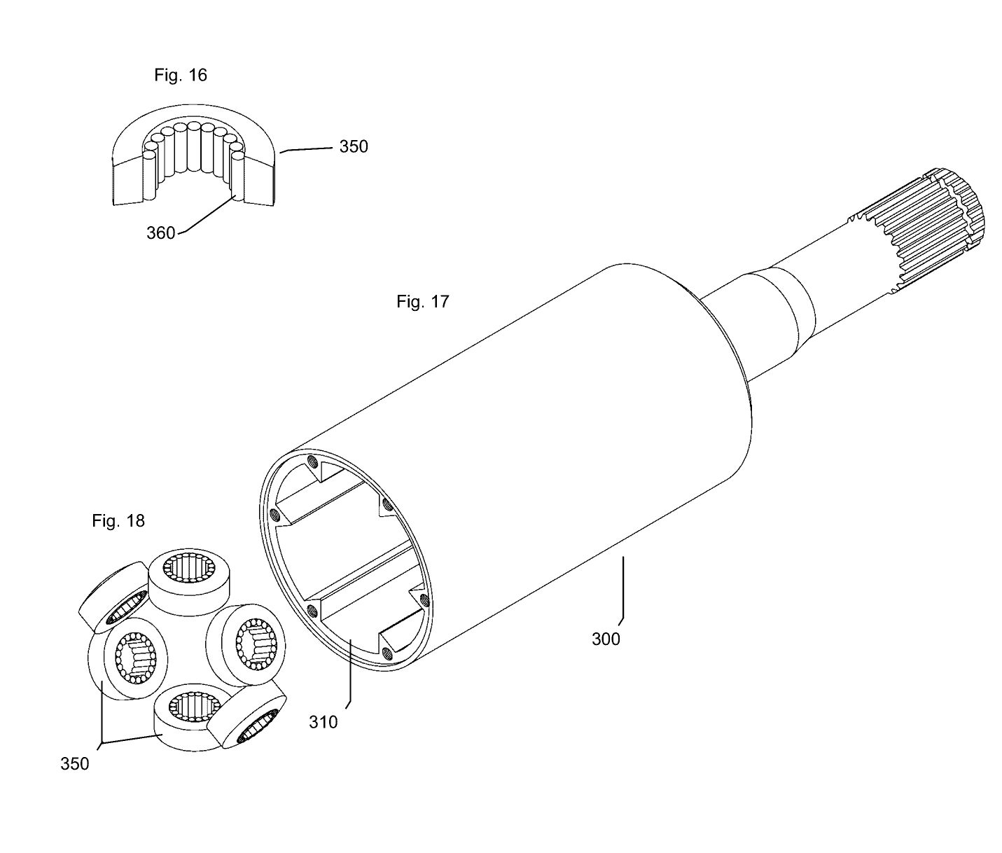

Needle roller bearings (350) comprise a plurality of needle rollers (360) connectable to an inner surface of needle roller bearings (350) as shown in FIG. 16 and FIG. 18. Needle roller bearings (350) can be aligned to fit in rectangular cross-section grooves (310) of outer part (300) of the disclosed device as shown in FIG. 17 and FIG. 18.

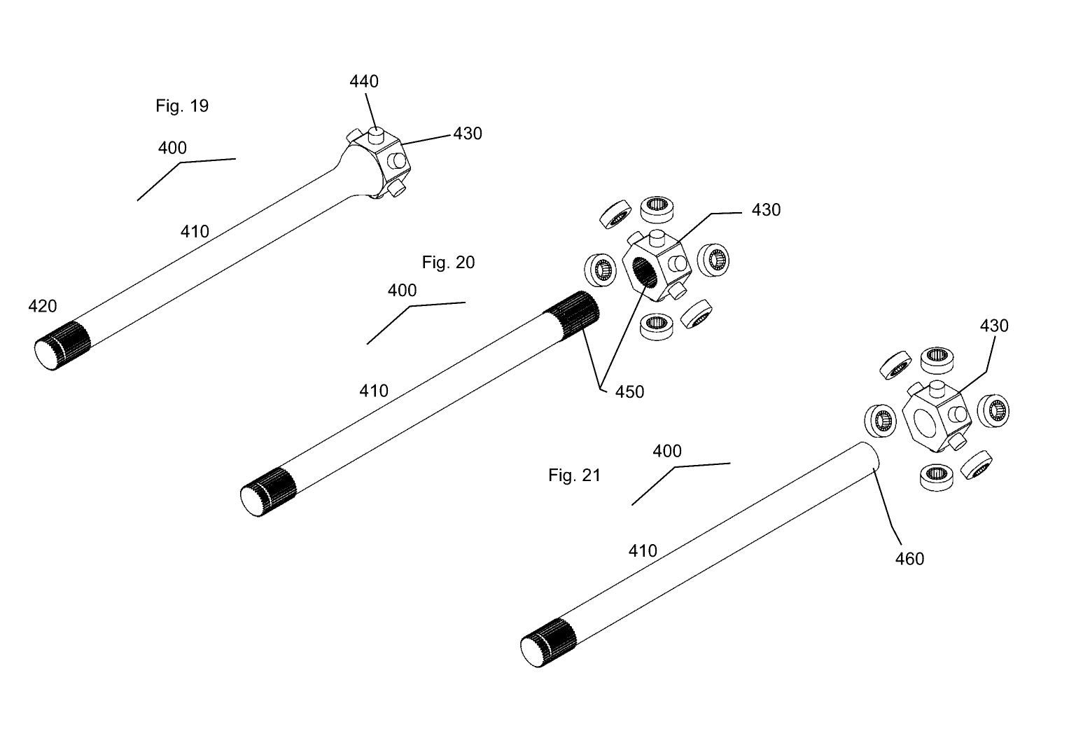

Inner part (400) of the disclosed device comprises a slender main shaft (410), a constant velocity joint connection (420), a shaft head (430) and roller pins (440) as shown in FIG. 19. Needle roller bearings (350) (see FIG. 16 and FIG. 18) are situated on roller pins (440). Inner part (400) may also be configured to connect to a universal joint.

Shaft head (430) with radially placed roller pins (440) may optionally be configured as a unitary part. In FIG. 20 shaft head (430) is connected to slender main shaft (410) via a spline (450) and in FIG. 21 shaft head (430) is affixed, i.e., welded to slender main shaft (410) at weld area (460).

The number of needle roller bearings (350) and corresponding grooves (310) and corresponding roller pins (440) are at least two. As contemplated, an embodiment may have two to eight needle roller bearings; however other configurations could be possible.

A conical shaft aligning connector (500) as shown in FIG. 22 is used for connecting inner part (400) and outer part (300) of the disclosed device. Needle roller bearings (350) are configured to fit in rectangular cross-section grooves (310) of outer part (300) and may thus roll in the grooves. Connector (500) comprises a flange (510) with bolt holes (520) for connection to inner threads (320) of outer part (300) of the disclosed device.

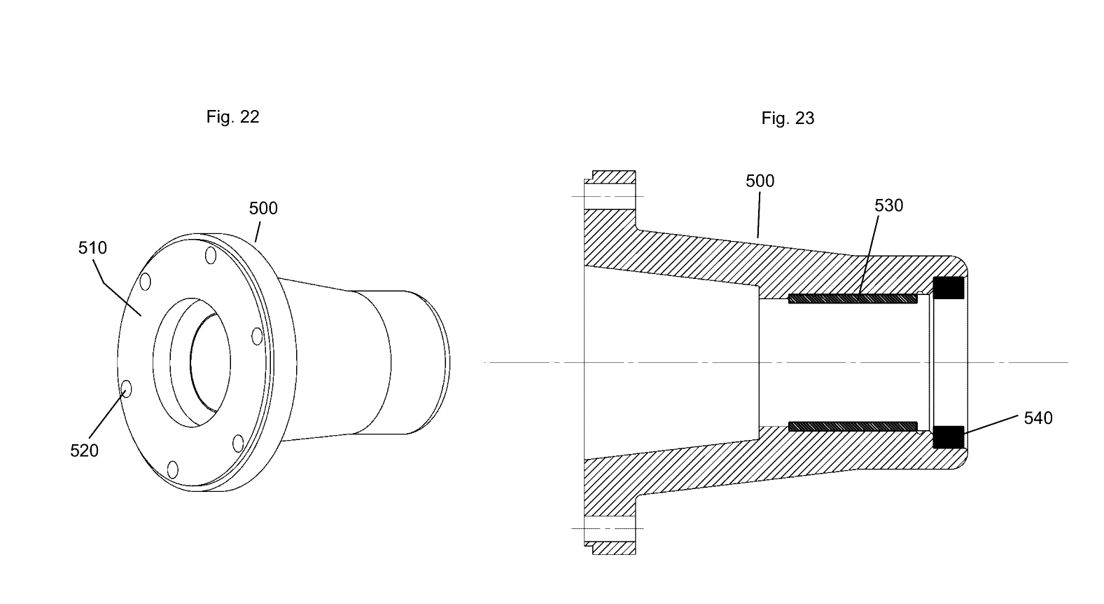

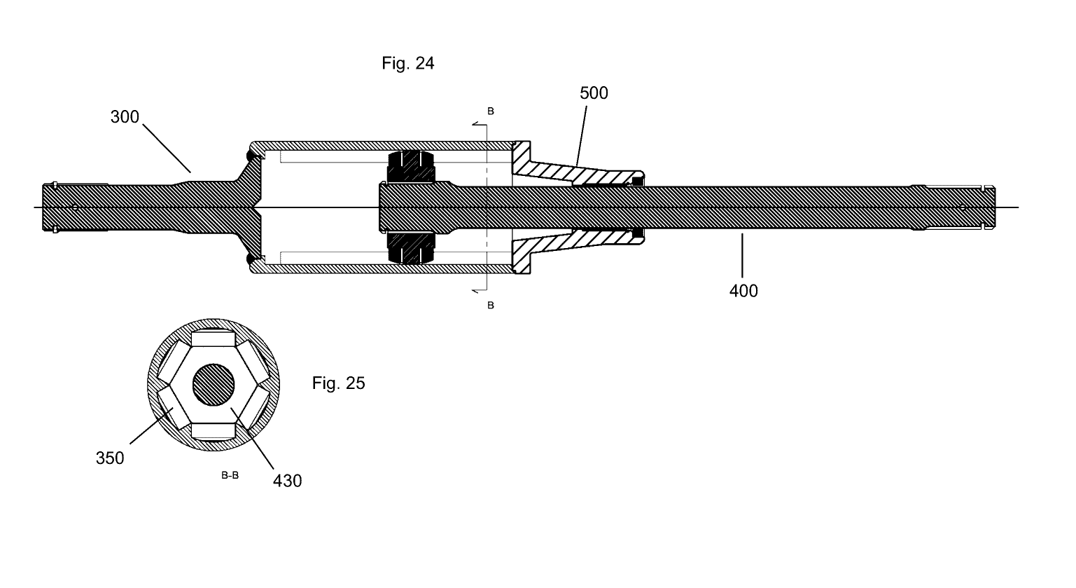

As shown in FIG. 23 connector (500) comprises a conventional sealing system with a bushing (530) and an oil and dust seal (540) to prevent or reduce lubricant seepage from inside the cylinder.

The disclosed device provides for long travel, low friction and improved torsional ductility along with efficient torque transfer.

Although the disclosed device has been described with reference to exemplary embodiments, numerous modifications and variations can be made and still the result will come within the scope of the disclosure. No limitation with respect to the specific embodiments disclosed herein is intended or should be inferred.

1. A telescopic half shaft comprising:
an inner part and an outer part, the inner part having two ends and rollers radially placed at one end thereof,
the outer part having internal grooves that align with the rollers of the inner part; and
wherein the inner part and the outer part are connected by a connector.

2. The telescopic half shaft of claim 1, wherein the inner part has a slender main shaft section and a head section, and wherein the slender main shaft section is substantially longer than the head section.

3. The telescopic half shaft of claim 2, wherein the head section of the inner part is connected to the slender main shaft section of the inner part by way of a spline.

4. The telescopic half shaft of claim 2, wherein the head section of the inner part is welded to the slender main shaft section of the inner part.

5. The telescopic half shaft of claim 1, wherein the inner part further comprises two to eight rollers.

6. The telescopic half shaft of claim 1, wherein the outer part further comprises two to eight grooves.

7. The telescopic half shaft of claim 1, wherein the outer part is configured to connect to a constant velocity joint connection or a universal joint connection.

8. The telescopic half shaft of claim 1, wherein the inner part is configured to connect to a constant velocity joint connection or a universal joint connection.

9. An inner part of a telescopic half shaft, the apparatus comprising two ends and rollers radially placed at one end thereof.

10. The apparatus of claim 9, wherein the inner part has a slender main shaft section and a head section, and wherein the slender main shaft section is substantially longer than the head section.

11. The apparatus of claim 10, wherein the head section is connected to the slender main shaft section by way of a spline.

12. The apparatus of claim 10, wherein the head section is welded to the slender main shaft section.

13. The apparatus of claim 9, further comprising two to eight rollers.

14. The apparatus of claim 9 configured to connect to a constant velocity joint connection or a universal joint connection.

15. The apparatus of claim 9 mateable with an outer part of a telescopic half shaft comprising internal rectangular cross-section grooves.

16. An outer part of a telescopic half shaft, the apparatus comprising internal rectangular cross-section grooves.

17. The apparatus of claim 16 configured to connect to a constant velocity joint connection or a universal joint connection.

18. The apparatus of claim 16, further comprising two to eight internal rectangular cross-section grooves.

19. The apparatus of claim 16 mateable with an inner part of a telescopic half shaft comprising two ends and rollers radially placed at one end thereof.
